(19) United States
(12) Patent Application Publication
(10) Pub. No.: US 2012/0265536 A1
(43) Pub. Date: Oct. 18, 2012

(54) APPARATUS AND METHOD FOR PROCESSING VOICE COMMAND

(75) Inventors: Soon Kwon Paik, Yongin (KR); Sueng Wan Yang, Gunpo (KR)

(73) Assignee: HYUNDAI MOTOR COMPANY, Seoul (KR)

(21) Appl. No.: 13/324,582

(22) Filed: Dec. 13, 2011

(30) Foreign Application Priority Data
Apr. 14, 2011 (KR) 10-2011-0034724

(51) Int. Cl. G10L 11/00

(52) U.S. Cl. 704/270; 704/E11.001

(57) ABSTRACT

Disclosed is a technique for processing voice commands. In particular, the disclose technique increases a voice recognition rate without performing a process of inputting separate voice commands by updating a voice command table based on interaction with a user by storing similar commands input by the user once those commands have been confirmed by the user as similar command.

### CROSS-REFERENCES TO RELATED APPLICATIONS

Priority to Korean patent application number 10-2011-0034724, filed on Apr. 14, 2011, which is incorporated by reference in its entirety, is claimed.

### BACKGROUND

1. Field of the Invention

The present invention relates to an apparatus and a method for processing voice to commands, and more particularly, to an apparatus and a method for processing voice commands to learn new voice commands based on interaction with a user.

2. Background of the Invention

Recently, vehicles have become equipped with various advanced electronic control apparatuses and convenience apparatuses due to the development of an electronic technology and consumer demand. Generally in these recent applications, operations of the electronic control apparatuses and the convenience apparatus are performed according to driver's voice commands.

In order to perform various operations of various electronic control apparatuses and convenience apparatuses equipped in a vehicle, the driver must input specific voice commands. Each apparatus is established with a table including a list of voice recognition commands appropriate for each application which is input by manufacturers at the time of production. The input voice commands are recognized from the table, and then, the corresponding operations are performed.

In establishing the list of voice recognition commands for each application for each apparatus, it is realistically impossible to consider the number of way a user will request a command. Therefore, a method for establishing a list of voice recognition commands based on a manufacturer's subject or sample survey data has been used as a baseline.

However, in the current systems are limited in that often time the user cannot remember a specific command or the system doe not recognize the specific way a user supplies voice commands due to the user's accent or pronunciation skills and therefore, the current system degrade the recognition rate of the voice commands. As a result, the system may not perform the desired operations simply because the system cannot understand the user's voice.

In addition, the current systems inform users of possible voice commands to through a manual or repetition by the system itself. Therefore, when the driver has not had the opportunity to study the commands, the driver may be able to obtain normal results for the desired operations.

### SUMMARY

The present invention has been made in an effort to provide an apparatus and a method for processing voice commands capable of increasing a voice recognition rate without performing a process of inputting separate voice commands by updating a voice command table based on interaction with a user.

According to an exemplary embodiment of the present invention, there is provided an apparatus for processing a voice command, including: a storage unit configured to store a voice command table; a voice command input unit configured to receive the voice commands from a user; a voice command recognition unit configured to recognize the voice commands received through the voice command input unit based on the voice command table; and a voice command processing unit configured to provide similar commands correlated with the input voice commands to the user and linking the similar commands selected from the user with the input voice commands to update the voice command table, when the voice command recognition unit recognizes the voice commands as an abnormal voice command.

According to another exemplary embodiment of the present invention, there is provided a method for processing a voice command, including: storing, by a storage unit, a voice command table; receiving, by a voice command input unit, the voice commands from a user; recognizing, by a voice command recognition unit, the input voice commands based on the voice command table; and providing, by a voice command processing unit, similar commands correlated with the input voice commands to the user and linking the similar commands selected from the user with the input voice commands to update the voice command table, when the voice command recognition unit recognizes the voice commands as abnormal voice commands.

### BRIEF DESCRIPTION OF THE DRAWINGS

The above and other objects and features of the present invention will become apparent from the following description of embodiments given in conjunction with the accompanying drawings, in which:

FIG. 1 is a configuration of an exemplary embodiment of an apparatus for processing voice commands according to an exemplary embodiment of the present invention; and

FIG. 2 is a flow chart of a method for processing voice commands according to another exemplary embodiment of the present invention.

### DETAILED DESCRIPTION

Hereinafter, exemplary embodiments of the present invention will be described in detail with reference to the accompanying drawings.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

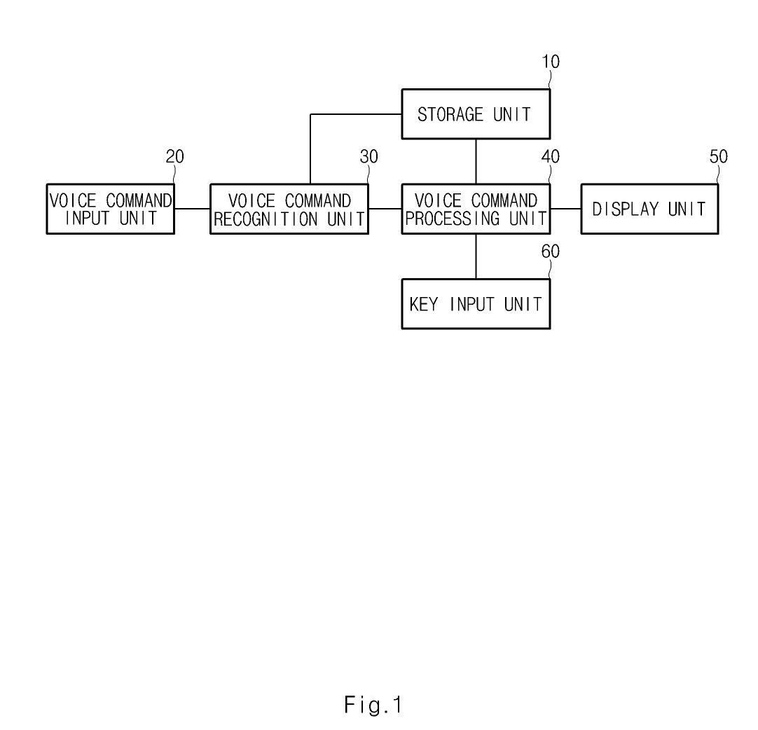

FIG. 1 is a configuration of an exemplary embodiment of an apparatus for to processing voice commands according to an exemplary embodiment of the present invention.

As shown in FIG. 1, the apparatus for processing voice commands according to the exemplary embodiment of the present invention includes a storage unit 10, a voice command input unit 20, a voice command recognition unit 30, a voice command processing unit 40, a display unit 50, and a key input unit 60.

Hereinafter, each component of the apparatus for processing voice commands will be described in detail below. The storage unit 10 stores a voice command table in which the voice commands indicating an operation of an electronic device such as the following [Table 1] are matched with the corresponding functions. In this case, the voice commands are commands indicating various operations of electronic devices, wherein specific commands activate specific operations. These command illustrated below are for exemplary purposes only and are not intended to limit the scope of the present invention.

TABLE 1

| No | Voice Command | Function |
|---|---|---|
| 1 | Call John Smith | Call John Smith |
| 2 | Show me the list | Show me the list |
| 3 | Turn the Volume up | Turn the Volume up |
| . | . | . |
| . | . | . |
| . | . | . |

The voice command input unit 20 receives the voice commands from the user. In this case, when the voice command input unit 20 is applied with power, the voice command input unit 20 may also be operated in an activation mode to receive the voice commands from the user and when the user inputs a signal intending to input the voice commands through the key input unit 60, the voice command input unit 20 may be activated to receive the voice commands from the user.

When the voice command input unit 20 is applied to a vehicle, the voice command input unit 20 may also be operated in an activation mode when a starting key of a vehicle is in an accessory state to transmit the input voice commands to the voice command recognition unit 30 and the voice command input unit 20 may also be activated when the user inputs the signal intending to input the voice commands through the key input unit 60 to receive the voice commands from the user.

The voice command recognition unit 30 determines whether the voice commands received through the voice command input unit 20 are present in the voice command table and if so, informs a driving control unit (not shown) to perform the corresponding function. If not, the voice command input unit 20 transmits the input voice commands and the corresponding recognized results to the voice command processing unit 40.

That is, the voice command recognition unit 30 does not transmit any information to the driving control unit when the voice commands received through the voice input unit 20 are commands that are not in the voice command table and thus, does not perform any operations at this time.

In this case, the voice command processing unit 40 receives the voice commands and the recognized results from the voice command recognition unit 30 displays similar commands correlating with each other in the voice command table through the display unit 50. Herein, the similar commands correlated with each other mean, by way of example, a phrase including the same or similar words. In response, the user selects the intended commands among the related similar commands displayed through the display unit 50.

Then, the voice command processing unit 40 links the voice commands transmitted from the command recognition unit 30 with the commands selected through the key input unit 60. That is, the voice command processing unit 40 matches the commands selected through the key input unit 60 with the voice commands transmitted from the voice command recognition unit 30 and stores the matched commands in the to voice command table.

In some embodiments, the voice command recognition unit 30 provides voice command numbers to the driving control unit so as to perform the user's intended function even though the similar commands are input from the voice command input unit 20 later on. That is, even though the user inputs the similar commands later on, the voice command recognition unit 30 may receive the functions corresponding to the voice commands matched with the similar commands because those similar commands have now been correlated with each other.

For example, when the user wants to call “John Smith,” if the voice command is set to be “Call Dr. Smith,” the user cannot call “John Smith” since the voice command is written in the voice command table as “Call John Smith.” That is, the voice command recognition unit 30 cannot search “Call Dr. Smith” in the voice command table since it is interpreted as an incorrect voice command. Thus, the unit 30 does not transmit the any results to the driving control unit but rather transmits the input “Call Dr. Smith” and the corresponding recognized results to the voice command processor 40.

In this case, the voice command processing unit 40 displays the “Call John Smith” that is a similar command in the voice command table and when the user selects “Call John Smith”, updates the voice command table as the following [Table 2].

TABLE 2

| No | Voice Command | Function |
|---|---|---|
| 1 | Call John Smith | Call John Smith |
| | Call Dr. Smith | |
| 2 | Show me the list | Show me the list |
| 3 | Turn the Volume up | Turn the Volume up |
| . | . | . |
| . | . | . |
| . | . | . |

The display unit 50 is configured to display various information. In particular, the display is configured to display a voice command list provided from the voice command processing unit 40. In this case, when the display unit 50 is a touch screen, the voice commands may be directly selected. In some embodiment of the present invention, the user may also select a command through voice command. (i.e., by selecting a number associated with a particular command).

The key input unit 60 includes various input methods such as a button type input method, voice listening input methods, and dial selection input methods.

The apparatus for processing voice commands according to the exemplary embodiment of the present invention may be installed in a telematics terminal and be applied to a telematics system including the telematics terminal and a telematics server, such that the input and display of the voice commands and the key input associated with the selection of the voice commands may be performed in the terminal and the update of the voice recognition and the voice command table may be performed in a remote telematics server.

In addition, when the voice commands received through the voice input unit 20 are commands that are not present in the voice command table and similar commands correlated with the commands are not present in the voice command table, the voice command processing unit 40 may be configured to monitor the key input that is input through the key input unit 60.

For example, when the user inputs the non-defined functions, for example, the voice command (bass control) to display a bass sound on a control screen, the voice commands are not stored in the voice command table and the similar commands are not also stored therein. Herein, even though the similar commands are stored in the voice command table, when a function setting signal is input through the key input unit 60, the following function definition operations are performed.

In this case, the voice command processing unit 40 stores the voice command called the “bass control” and monitors the key input unit 60, such that the user defines the to display function of the bass control screen corresponding to the ‘bass control’ commanded by the user. This can be appreciated through a log file.

Thereafter, the voice command processing unit 40 adds the ‘bass control’ to the voice command table and adds ‘show bass sound control screen’ as the corresponding function. Further, the user may change and delete the defined voice commands and the corresponding functions through key buttons (cancellation, input, storage, or the like) or a designated voice command.

Through the above system and process, the user may add the voice commands and add the corresponding functions, thereby maximizing the user's automotive experience.

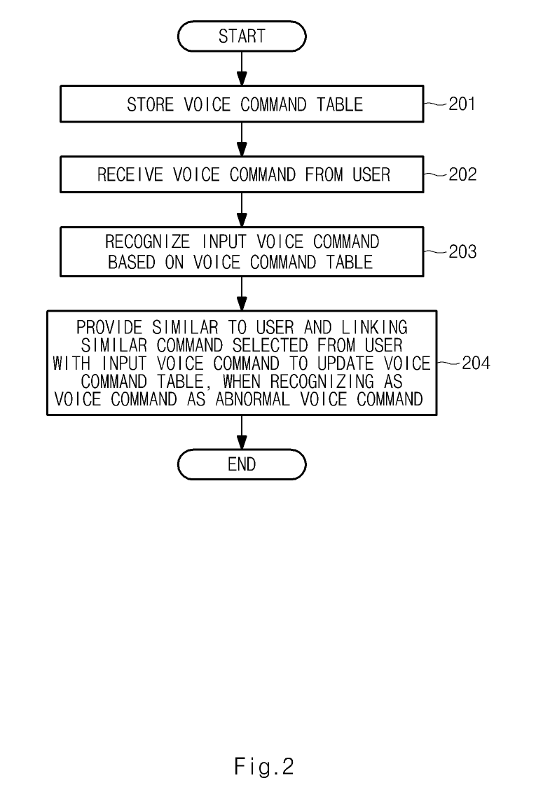

FIG. 2 is a flow chart of a method for processing voice commands according to another exemplary embodiment of the present invention. First, the storage unit 10 stores the voice command table (201). Thereafter, the voice command input unit 20 receives the voice commands from the user (202). Next, the voice command recognition unit 30 recognizes the voice commands input through the voice command input unit 20 based on the voice command table (203). Then, when the voice command recognition unit 30 recognizes the voice commands as abnormal voice commands, the voice command processing unit 40 provides the similar commands correlated with the input voice commands to the user and links the input voice commands with the similar commands selected from the user to update the voice command table (204).

Through above process, the user may simply set the voice commands without inputting the separate voice commands individually, such that the voice recognition rate may be improved in connection with the voice recognition system.

Although the above exemplary embodiment is described as using a plurality of units to perform the above process, it is understood that the above processes may also be performed by a single controller or unit.

Furthermore, the control logic of the present invention may be embodied as to computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server.”

As set forth above, the exemplary embodiments of the present invention can increase the voice command recognition rate without performing the process of inputting the separate voice commands by providing the similar commands list correlated with the voice commands and linking the similar commands selected from the user with the voice commands, since the voice commands from the user are not present on the database.

While the invention has been shown and described with respect to the preferred embodiments, it will be understood by those skilled in the art that various changes and modifications may be made without departing from the scope of the invention as defined in the following claims.

What is claimed is:

1. A system for processing voice commands, comprising:
a storage unit configured to receive a voice command table;
a first unit configured to receive the voice commands from a user;
a second unit configured to recognize the voice commands received through the first unit based on the voice command table; and
a third unit configured to provide similar commands correlated with the input voice commands to the user and linking the similar commands selected from the user with the input voice commands to update the voice command table, when the voice command recognition unit recognizes the voice commands as abnormal voice commands.

2. The system of claim 1, wherein the first unit is operated as an activation mode when a starting key of a vehicle is in an accessory state to transmit the voice command input from the user to the second unit.

3. The system of claim 1, wherein the second unit transmits the voice commands and the corresponding analysis results to the third unit when the voice commands input through the first unit are abnormal.

4. The system of claim 1, wherein the similar commands include the voice commands that include same words.

5. A method for processing voice commands, comprising:
storing, by a storage unit, a voice command table;
receiving, by a first unit, the voice commands from a user;
recognizing, by a second unit, the input voice commands based on the voice command table; and
providing, by a third unit, similar commands correlated with the input voice commands to the user and linking the similar commands selected from the user with the input voice commands to update the voice command table, when the voice command recognition unit recognizes the voice commands as abnormal voice commands.

6. The method of claim 5, wherein the inputting of the voice commands includes receiving the voice commands of the user when a starting key of a vehicle is in an accessory state.

7. The method of claim 5, wherein the similar commands are the voice commands including same words.

8. A computer readable medium containing program instruction executed by a controller, the computer readable medium comprising:
program instructions that store a voice command table;
program instructions that receive the voice commands from a user;
program instructions that receive the input voice commands based on the voice command table; and
program instructions that provide similar commands correlated with the input voice commands to the user and linking the similar commands selected from the user with the input voice commands to update the voice command table, when the voice command recognition unit recognizes the voice commands as abnormal voice commands

9. The method of claim 8, wherein the inputting of the voice commands includes receiving the voice commands of the user when a starting key of a vehicle is in an accessory state.

10. The method of claim 8, wherein the similar commands are the voice commands including same words.
